(19) United States
(12) Patent Application Publication
(10) Pub. No.: US 2014/0172292 A1
(43) Pub. Date: Jun. 19, 2014

(54) Methods and Apparatus for Context Based Trip Planning

(71) Applicant: FORD GLOBAL TECHNOLOGIES, LLC, Dearborn, MI (US)

(72) Inventors: Ryan Abraham McGee, Ann Arbor, MI (US); Dimitar Petrov Filev, Novi, MI (US); Johannes Geir Kristinsson, Ann Arbor, MI (US); Fling Tseng, Ann Arbor, MI (US); Anthony Mark Phillips, Northville, MI (US)

(73) Assignee: FORD GLOBAL TECHNOLOGIES, LLC, Dearborn, MI (US)

(21) Appl. No.: 13/714,919

(22) Filed: Dec. 14, 2012

(51) Int. Cl. G01C 21/34

(52) U.S. Cl. CPC G01C 21/343
USPC 701/418

(57) ABSTRACT

A system includes a processor configured to receive vehicle location and context information. The processor is also configured to execute a prediction algorithm to predict one or more next-destinations based on the location and context information compared to observed driver behavior stored in a database and deliver the one or more next-destinations to a vehicle computing system. The processor is further configured to receive next-destination input and utilizing the next-destination input as a new vehicle location and estimating new context information, repeat execution of the prediction algorithm, delivery of the predicted next-destinations, and receipt of the next-destination input, until input indicating completed journey assembly is received.

### TECHNICAL FIELD

The illustrative embodiments generally relate to methods and apparatus for context based trip planning

### BACKGROUND

Trip planning in a navigation system often involves compiling a list of all considered stop locations and a series of actions to make the sequence match the planned trip. There are many ways of selecting a stop location, including, but not limited to, entering an address of a never-been-before visited location, selecting a location by pointing at a map, selecting a location from a list of previously visited locations and/or selecting a location from a list of points of interest (POIs).

The last two methods may involve selections made from a list. These lists are generally based on the name of the location/POI, the time since last visit, or the frequency of visits. Even though this seems a relatively simple process, it can involve extensive scrolling through a list to find the correct choices, especially on small screens where not many rows can be shown at once.

The difficulties with destination entry become especially apparent when a series of stops (trip-chain) is planned, e.g. the complete set of trips intended for that day, because of the number of variables that need to be considered.

One example of determining destinations discussed in U.S. Patent Application 2009/0105934, which generally relates to a destination prediction device, includes: a map information accumulation unit that accumulates map information including at least positions of a plurality of points on a map and routes between the plurality of points; a start position acquisition unit that acquires a start position of the mobile body; a current position acquisition unit (that acquires a current position of the mobile body; a destination candidate position acquisition unit (that acquires positions of a plurality of destination candidates that may potentially become destinations of the mobile body from the map information accumulation unit based on the acquired current position; a. circuitousness calculation unit that calculates a circuitousness which is a deviation of a route from the start position to the position of the destination candidate including the current position with respect to a route having minimum route cost from the start position to the position of the destination candidate; and a destination prediction unit that predicts, as a destination, a destination candidate whose calculated circuitousness is the smallest among the destination candidates.

In another example, U.S. Pat. No. 7,280,915 generally relates to a CPU of a navigation device that includes a clock unit, a continuous driving time measurement unit that measures continuous driving time from a traveling start time, a course stage prediction unit, and a presenting information controller. The course stage prediction unit selects based on the traveling start time, a. first transition determination reference time for transition from a “first stage” to a “middle stage” from prepared data of the first transition determination reference time and a second transition determination reference time for transition from the “middle stage” to a “last stage” from prepared data of the second transition determination reference time. The course stage prediction unit then predicts a course stage by comparing the continuous driving time with the selected transition determination reference times. Depending on the predicted course stage, the presenting information controller presents information convenient for a driver in the predicted course stage.

### SUMMARY

In a first illustrative embodiment, a system includes a processor configured to receive vehicle location and context information. The processor is also configured to execute a prediction algorithm to predict one or more next-destinations based on the location and context information compared to observed driver behavior stored in a database and deliver the one or more next-destinations to a vehicle computing system. The processor is further configured to receive next-destination input and utilizing the next-destination input as a new vehicle location and estimating new context information, repeat execution of the prediction algorithm, delivery of the predicted next-destinations, and receipt of the next-destination input, until input indicating completed journey assembly is received.

In a second illustrative embodiment, a computer-implemented method includes receiving vehicle location and context information. The method also includes predicting one or more next-destinations, via a computer, based on the location and context information compared to observed driver behavior. Further, the method includes delivering the one or more next-destinations to a vehicle and receiving next-destination input. The illustrative method also includes utilizing the next-destination input as a new vehicle location and estimating new context information, repeating the steps of predicting, delivering, and receiving input, until input indicating completed journey assembly is received.

In a third illustrative embodiment, a computer-readable storage medium stores instructions, which, when executed by a processor, cause the processor to perform a method including receiving vehicle location and context information. The performed method also includes predicting one or more next-destinations based on the location and context information compared to observed driver behavior and delivering the one or more next-destinations to a vehicle. Also, the method includes receiving next-destination input and, utilizing the next-destination input as a new vehicle location and estimating new context information, repeating the steps of predicting, delivering, and receiving input, until input indicating completed journey assembly is received.

### BRIEF DESCRIPTION OF THE DRAWINGS

FIG. 1 shows an illustrative example of a vehicle computing system;

FIG. 2 shows an illustrative example of a navigation prediction system;

FIG. 3 shows an illustrative example of a trip building process;

FIG. 4 shows an illustrative example of a destination selection process;

FIG. 5 shows an illustrative example of a destination selection screen; and

FIG. 6 shows an illustrative example of a trip output.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

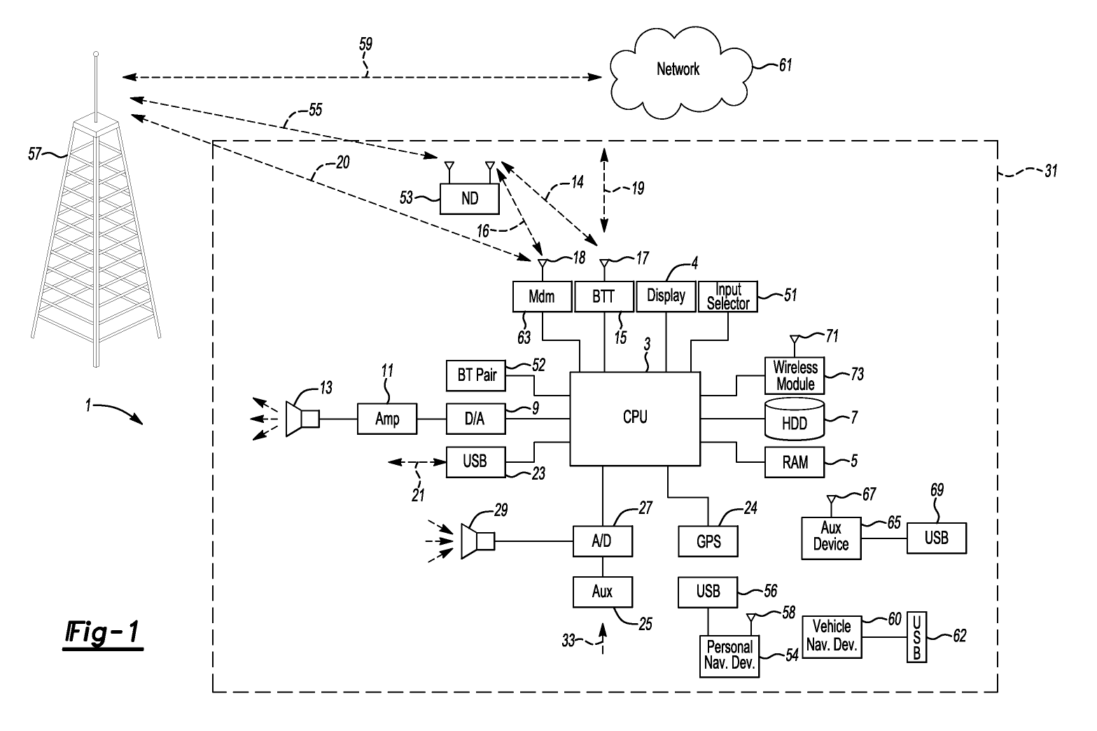

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself One of ordinary skill in the art will understand when it is inappropriate to apply a particular VACS to a given solution. In all solutions, it is contemplated that at least the vehicle computing system (VCS) located within the vehicle itself is capable of performing the exemplary processes.

The illustrative embodiments propose a way of using trip prediction for improving powertrain features, in order to aid the driver's destination entry in the Navigation system by suggesting destinations for the immediate upcoming trip or set of trips (trip-chain).

Based on the vehicle's previous driving history—more explicitly previous stop locations and their contextual information (when they were visited and their relationship with each other)—the system can deliver to the driver a list of most probable destinations based on the current Time-of-Day (ToD), Day-of-Week (DoW), location, previous driving history, etc. Because of this, the driver can be given a much shorter list of possible stop locations with much higher relevance from which to choose his intended destination—in most cases the locations that are presented to the driver are ones that he has visited around the same Time-of-Day and Day-of-Week from a similar location. Since travel time and stop duration are encapsulated in the predicted vector, predicted stop locations changes dynamically with the driver's selection of subsequent stop locations along his planned trip according to past driving patterns.

As a result, the system is designed to reduce amount of time and effort from the driver during the process of trip planning with multiple stops (Trip-Chain). This may be achieved by dynamically populating next locations as the driver confirms one or a sequence of trip destinations.

Destination prediction is described in commonly owned and co-pending application ______, filed on ______, the contents of which are hereby incorporated by reference.

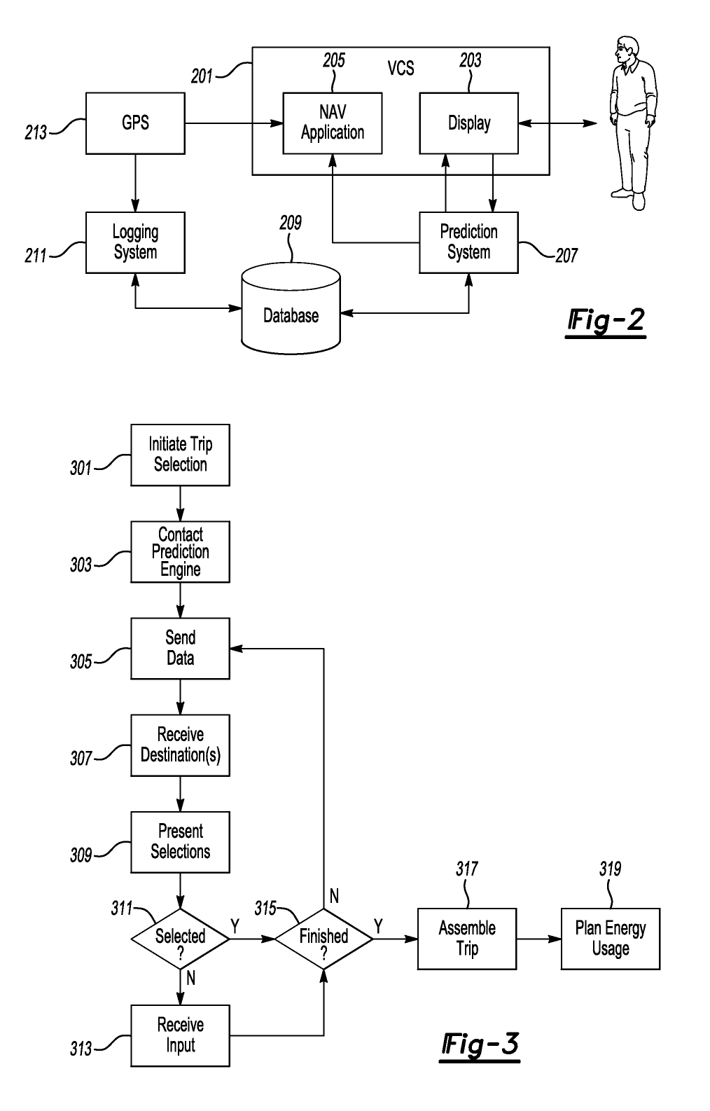

FIG. 2 shows an illustrative example of a navigation prediction system.

The exemplary system has two operational parts, a Logging System 211 and a Prediction System 207. The Logging System may be a continuously running system that always monitors the vehicle's usage, and stores this data in a database 209.

The Prediction System may be invoked by a Navigation Application 205 whenever there is a need for the driver to provide the next destination. This can be, for example, manually when the driver wants navigation assistance, or automatically triggered by the Navigation Application when the vehicle is started. The Navigation Application asks the Prediction System to provide a prediction of the next upcoming trip(s) and provides the current Location and Time information (current Time-of-Day and Day-of-Week) with this request. The Prediction System uses the data stored in the database together with the current context (including GPS coordinates 213) to provide a list of possible destinations, which it presents to the driver on a screen 203 of an infotainment system 201. The driver selects the correct location of the presented alternatives. If none of them matches the intended destination he/she can also enter the correct destination using traditional means of entry such as providing an address using the on-screen keyboard, speaking an address using a voice-recognition system or searching through an existing set of Points-of-Interest (POIs).

If enabled, the Prediction System can also use the newly indicated destination in order to predict where the driver will be heading at the subsequent trip, and thus let him plan a full chain of trips. This is extra useful in electrified vehicles such as Battery Electric Vehicles (BEVs) and Plug-in Hybrid Electric Vehicles (PEHVs) where the vehicle needs to know how far it will be driven before being charged again. When the driver is satisfied with his selection(s) the Destinations is forwarded to back to the Navigation Application.

FIG. 3 shows an illustrative example of a trip building process. In this illustrative embodiment, the trip planning system utilizes a string of predictions based on changing context variables to build an entire trip plan for a day. The trip plan can then be used for providing a driver with directions, re-routing a driver, energy management, etc.

In this example, the driver may initiate a trip selection process. This can be done, for example, by activating a navigation application running on a vehicle infotainment system. The navigation application can utilize local and/or cloud-based resources to provide a trip building experience. In this example, the process contacts a prediction engine 303 based in the cloud. By using a cloud-based system, powerful computing resources can be employed without having to provide those resources to each individual vehicle.

Following contact of the prediction engine, the process can send data relating to the current context to the engine. For example, without limitation, this data can include information such as time of day, day of week, driver current location, current driver of the vehicle (knowable based on, for example, a paired phone's owner), current vehicle speed and heading, and any other known information relating to driver/vehicle context.

The first time through the process, it may be the case that no current destination has yet been selected. The prediction engine, however, can produce a number of possible destinations based on a predictive algorithm, which are then received by the local process 307. Although there may be more than one possible destination produced, since the destinations are based on past observed experiences, it is likely that the list of recommended destinations is relatively short and often has a high correlation to actual destinations that a driver intends to visit. For example, without limitation, if a driver goes to work, Monday through Friday, between seven and eight AM, then “work” will likely be one of the possible destinations if a vehicle is driven by that driver during that time period on those days of the week.

A list of the selections can be presented to the driver for selection of the specific destination desired 309. While the prediction algorithm may generally be accurate, it is always possible that a particular driver intends to deviate from the current paradigm, (e.g., a grocery stop on the way home from work). In such a case, the driver may elect not to select 311 one of the presented destinations, but instead input a particular destination to which the driver intends to travel 313.

Whether a destination is selected or a destination is input, this destination will form one stop on a trip. If the trip entry is completed 315, the process can move on, otherwise the destination prediction and input may continue. Since the prediction algorithm has access to a variety of information, including the likely travel time and location of each selected destination, future prediction information can be based as if it were being provided at the time/location of the previous destination to that point. Additionally, historical behavior can indicate a likely amount of time to be spent at any known destination, which can aid in estimating the likely time of departure and further assist in providing accurate information with regards to predicting a next destination based on observed behavior.

Once the destinations have all been selected and/or input, the process can assemble a complete trip 317. This can then be delivered to a user to show trip information, such as total travel time, arrival time(s), distances traveled, etc. Additionally, other information can be obtained and/or calculated utilizing this information. For example, a gas-based vehicle can predict if there is enough gasoline in the vehicle to complete the trip, and inform the user if there is a need to refuel. In an electric or hybrid vehicle, the process can utilize trip information to either recommend a recharge point or manage (and inform) a driver of an energy usage strategy designed to ensure that the driver can likely complete the trip without recharging the vehicle 319.

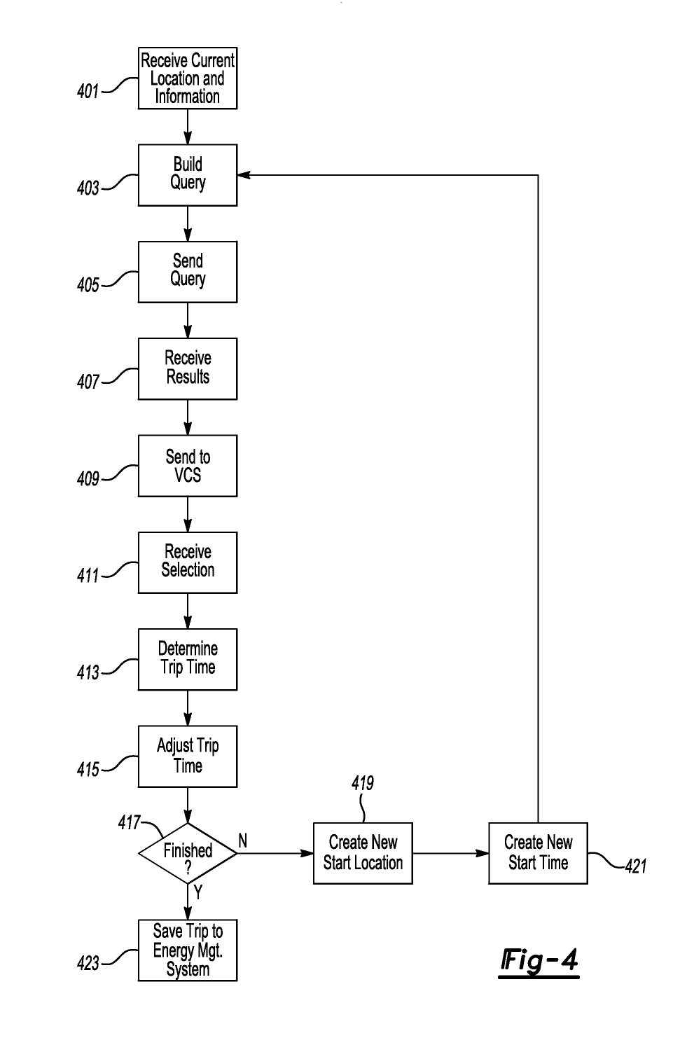

FIG. 4 shows an illustrative example of a destination selection process. This is a back-end process that can, for example, be run on the cloud to select a number of likely next-destinations. In this example, the process receives a number of context-relevant pieces of information from the vehicle, including, but not limited to, a current vehicle location and driver information 401. Driver information may be useful because different drivers in a vehicle at the same time of day may have different common destinations (e.g., one spouse using a vehicle at noon may be going to a store, the other may be going to lunch).

Based on the received information, the process can build a query 403 to determine likely destinations. Presumably, as more information about driver habits is gathered over time, the process will become more and more accurate with the predicted destinations. The query can then be sent to the database 405 and the results can be received from the database 407.

If there are too many results received, the process may pare down the results to a threshold number, or all results may be sent along together 409. The results can then be received by the vehicle computing system, where they can be viewed by the driver and a selection of a destination can be made (or entered). Once a destination has been selected or entered, the process may receive the results 411. These can be the selected results, or the results of a destination entry.

Based on the selected/entered destination, the process may determine a likely trip time to the destination 413. This can be based on traffic information, driver habits, weather information, etc., or, in a more simplistic case, simply be based on distance and likely speed of travel (based on speed limits). In addition to calculating travel time, the process may also calculate a trip time adjustment based on a likely amount of time to be spent at a destination 415. In the case of known destinations, this time can be calculated based on observations about how much time the driver commonly spends at this destination.

If the destination entered does not correspond to any of the possible selections, it may be difficult for the system to calculate the time to be spent at the destination. Several modeling solutions can aid in this problem, however. In one instance, the destination may be a known destination, just not one that was predicted for that portion of the journey. In such a case, the entered destination can be compared to a list of all known destinations for that user and then the stored observed average time spent at the location can be used to predict how long the user will be at that location.

Even in the instances where the destination does not correspond to a known destination, predictions about time at location can be made. For example, if the location was a gas station, the system could refer to how long a user typically spends at known gas stations. The same can be said for a number of common business types. In the case of a business whose type is unknown for that user, the system could even look at other similarly situated users (or all users) to determine how long those users typically spend at such a business. For example, if a user visited a flower store for the first time, the system may have no reference for that user, but may know that typically drivers spend fifteen minutes at flower stores.

Once the appropriate adjustment has been made to a trip time 415, the process then determines if a notification that trip selection has been completed is received 417. If the trip selection process is completed, the trip is saved and can be relayed to other process for, for example, determination of an energy management strategy 423, delivery to a driver, etc.

If there are still destinations needing to be selected, the process creates a new “start location” 419 based on the current last-destination. This should be a reasonably accurate projection of location since the physical destination(s) are known. The process also creates a new “start time” based on a projected time of travel and duration of stops at all destinations. This may be less accurate, since the process is guessing based on past observed behavior, but can still be predicted with a fair likelihood of success. As long as the selection and prediction process continues, the system can continue to generate new start locations and times for prediction of a next-destination.

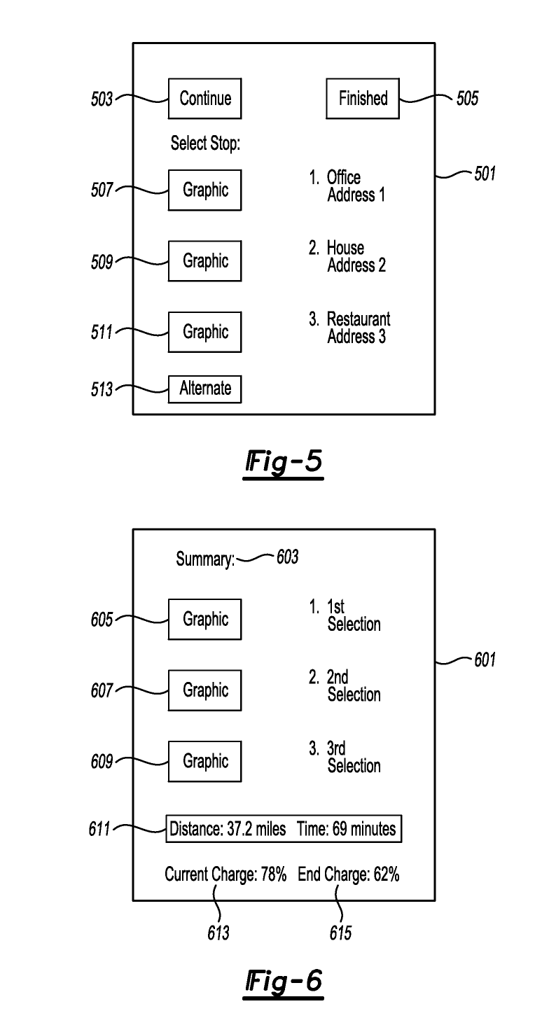

FIG. 5 shows an illustrative example of a destination selection screen 501. In this illustrative example, the display shows a variety of possible selection options 507, 509, 511. In this example, each option is a graphic relating to the particular option, such as, for example, a logo of a business. These could also simply be buttons corresponding to each selection, or, in another example, do not need to be displayed at all, if, for example, the addresses themselves are selectable.

Corresponding to each displayed button, a location address and/or name is displayed. This provides a driver with additional information about each destination. If there is a common name (e.g., house, work, etc.) or a business name (e.g., Kroger) assigned to a given destination, this may also be displayed here.

In some instances, the driver may not wish to travel to any of the destinations, and may instead choose to enter an alternate destination 513. Selection of the “alternate” button can launch a common navigation application, allowing a driver to enter an address, search for a business, etc., returning to the illustrative screen once address selection is complete. Also, in some instances, the process may have more than three destinations, but only room for display of three at a time. In this case, the driver may select a continue button 503 to view other predicted destinations. Once the trip selection is completed in its entirety, the driver can select the “finished” button 505.

FIG. 6 shows an illustrative example of a trip output 601. After an entire trip has been entered by a driver, the process may present a summary 603 of a the trip to a driver. In this example, the driver is driving a hybrid or fully electric vehicle, and correspondingly, charge information may be presented. Here, the energy management system may present a current charge 613 and a predicted end charge 615. The end charge will likely result from following a recommended energy management strategy, and can vary as the driver travels. Recommended travel routes, travel speeds, etc. can be presented to a driver as the driver travels to map out an energy usage strategy.

Additionally, stop information for each location can be shown 605, 607, 609 as well as total travel distance and time 611. Once a journey has begun, the travel time and distance may adjust to reflect the first destination, for example. Other suitable information may also be output to the driver as acceptable.

In a non-limiting example, an illustrative system as described herein may operate as follows:

When the vehicle is started up, the Navigation Application asks the Prediction System to provide a prediction on the upcoming destination. It provides the currently identified location, time and date with this request. The Prediction System presents this contextual information so that the driver can confirm it and start the prediction. Upon confirmation, the Prediction System uses the current location and time to build a query made to the database for a list of probable next stop locations.

The result from the query is reformatted and presented to the driver. The suggested locations are the top most likely stops the driver made during his previous trips originated from the same location (home) around similar time frame (Monday morning).

The driver picks his carpool friend John's home as the 1^{st} stop, then selects “Continue” indicating there is an additional known stop after the current selection. The system takes this piece of information and the internal prediction engine forms a new query to predict the 2^{nd} stop location list. The system will use the initial destination as the “origin” for the second trip. It will also use previously recorded knowledge about the time the first trip should take, and average stopping time at the first destination to determine most likely starting time for that trip. The system again takes the result of the prediction and presents them to the driver. Then, the driver selects his office as the second and final stop for the trip and then clicks “Finished” to end the planning for this trip-chain. The system now internally pieces together information communicated with the driver about the planned stops during the trip.

The two stops the driver selected are highlighted with related trip information and the total distance and trip time are estimated from these trips. The resulting trip (2 stops) is then shown to the driver as a final confirmation of his planned trip.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system comprising:
a processor configured to:
receive vehicle location and context information;
execute a prediction algorithm to predict one or more next-destinations based on the location and context information compared to observed driver behavior stored in a database;
deliver the one or more next-destinations to a vehicle computing system;
receive a driver-selected next-destination input, selected from the delivered one or more next-destinations; and
utilize the next-destination input as a new vehicle location and estimate new context information, repeat execution of the prediction algorithm, delivery of the predicted next-destinations, and receipt of the next-destination input, until input indicating completed journey assembly is received.

2. The system of claim 1, wherein the context information includes driver identity.

3. The system of claim 1, wherein the context information includes a day of week.

4. The system of claim 1, wherein the context information includes a time of day.

5. The system of claim 1, wherein the estimated new context information includes a new time of day based at least in part on travel time to the new vehicle location from a previous vehicle location.

6. The system of claim 1, wherein the estimated new context information includes a new time of day based at least in part on projected time spent at the new vehicle location.

7. The system of claim 6, wherein the projected time spent at the new vehicle location is based at least in part on observed driver behavior stored in the database.

8. The system of claim 6, wherein the projected time spent at the new vehicle location is based at least in part on observed driver behavior stored in the database with relation to a business of a similar type as a business located at the new vehicle location.

9. The system of claim 6, wherein the projected time spent at the new vehicle location is based at least in part on observed driver behavior stored in the database for other drivers visiting a business of a similar type as a business located at the new vehicle location.

10. A computer-implemented method comprising:
receiving vehicle location and context information;
predicting multiple next-destinations, via a computer, based on the location and context information compared to observed driver behavior;
delivering the next-destinations to a vehicle;
receiving driver-selected next-destination input, selected from the delivered next-destination; and
utilizing the next-destination input as a new vehicle location and estimating new context information, repeating the steps of predicting, delivering, and receiving input, until input indicating completed journey assembly is received.

11. The method of claim 10, wherein the context information includes driver identity.

12. The method of claim 10, wherein the context information includes a day of week.

13. The method of claim 10, wherein the context information includes a time of day.

14. The method of claim 10, wherein the estimated new context information includes a new time of day based at least in part on travel time to the new vehicle location from a previous vehicle location.

15. The method of claim 10, wherein the estimated new context information includes a new time of day based at least in part on projected time spent at the new vehicle location.

16. The method of claim 15, wherein the projected time spent at the new vehicle location is based at least in part on observed driver behavior.

17. The method of claim 15, wherein the projected time spent at the new vehicle location is based at least in part on observed driver behavior stored in a database with relation to a business of a similar type as a business located at the new vehicle location.

18. The method of claim 15, wherein the projected time spent at the new vehicle location is based at least in part on observed driver behavior stored in a database for other drivers visiting a business of a similar type as a business located at the new vehicle location.

19. A non-transitory computer-readable storage medium storing instructions, which, when executed by a processor, cause the processor to perform a method comprising:
receiving vehicle location and context information;
predicting multiple next-destinations based on the location and context information compared to observed driver behavior;
delivering the next-destinations to a vehicle;
receiving driver-selected next-destination input, selected from the delivered next-destinations; and
utilizing the next-destination input as a new vehicle location and estimating new context information, repeating the steps of predicting, delivering, and receiving input, until input indicating completed journey assembly is received.

20. The computer readable storage medium of claim 19, wherein the context information includes driver identity information.
